(19) United States
(12) Patent Application Publication
(10) Pub. No.: US 2007/0262089 A1
(43) Pub. Date: Nov. 15, 2007

(54) Apparatus for dispensing food product

(75) Inventor: Mark V. LeGreve, Two Rivers, WI (US)

Correspondence Address: FOLEY & LARDNER LLP, 777 EAST WISCONSIN AVENUE, MILWAUKEE, WI, 53202-5306, US

(73) Assignee: The Vollrath Company, L.L.C.

(21) Appl. No.: 11/431,887

(22) Filed: May 10, 2006

(51) Int. Cl. B67D 5/58; A47G 19/24

(52) U.S. Cl. 222/189.02; 222/565; 222/470

(57) ABSTRACT

A utensil is disclosed. The utensil comprises a handle, a receptacle, and a lid. The receptacle is coupled to the handle and comprises a rim defining an opening in the receptacle. The lid comprises a plurality of apertures and is movably coupled to the receptacle or the handle so as to move between a first position and a second position. In the first position, the lid extends across and opposite to the rim. In the second position, the lid is disposed offset from the receptacle to expose at least a portion of the rim. The receptacle is configured to receive material when the lid is in the second position and the perforated lid is configured to allow the material to be dispensed when the lid is in the first position

### BACKGROUND

The present invention relates generally to an apparatus for serving predetermined portions of a product. More specifically, the present invention relates to an apparatus including a receptacle and a moveable cover that is configured to dispense the product through one or more dispensing apertures.

Receptacle devices, commonly known as scoops or dishers, are used for serving predetermined portions of a product. Dishers are well known in the art and are often used in food service environments where the server wishes to serve consistent predetermined portions of food product. Dishers may also be used in the preparation of food when a consistent predetermined amount of an ingredients is desired. For example, dishers may be used with a particulate foodstuff, such as spices or grated cheeses that are often distributed by being shaken through a series of apertures or perforations.

Accordingly, it would be advantageous to have a serving device that can consistently collect a predetermined amount of a product and dispense it in a graduated manner such as through a series of apertures. It would further be advantageous to have a serving device with a perforated lid that is moveable between a first position in which the serving receptacle is substantially uncovered and a second position in which the serving receptacle is substantially covered. To provide an inexpensive, reliable, and widely adaptable apparatus for dispensing product that avoids the above-referenced and other problems would represent a significant advance in the art.

### SUMMARY

One embodiment of the invention relates to an apparatus for serving predetermined portions of a product. The apparatus comprises a server assembly which includes a receptacle that holds the product, a handle assembly that is configure to be coupled to the receptacle and held by the user, a product separation assembly that is configured to separate the product from the interior surface of the receptacle, and a perforated lid that is moveable between an open and a closed position and is configured to cover the receptacle so the product can be dispensed through a series of perforations provided in the lid.

The present invention relates to a utensil comprising an elongated handle; a receptacle coupled to the handle and comprising a rim defining an opening in the receptacle; and a perforated lid movably coupled to one of the receptacle and the handle so as to move between a first position in which the lid extends across and opposite to substantially any portion of the rim and a second position in which the lid is disposed offset from the receptacle to expose at least a portion of the rim. The receptacle is configured to receive material when the lid is in the second position and the perforated lid is configured to allow the material to be dispensed when the lid is in the first position. The utensil may comprise a manual depressant surface extending from the lid and configured to be engaged by a user's thumb of a hand which the user's fingers of the hand are wrapped about the handle.

The present invention also relates to a method comprising moving a lid by actuating a lever from a first position in which the lid is opposite a receptacle to a second position in which the lid at least partially exposes a cavity defined by the receptacle; inserting the receptacle into material such that the material enters the receptacle through a rim that defines an opening in the receptacle; moving the lid across the rim to a second position; and dispensing the material within the receptacle through one or more perforations in the lid.

The present invention further relates to a utensil comprising an elongated handle, a bowl, a cover, and a lever. The bowl is coupled to the handle and comprises a mouth. The cover comprises a plurality of apertures and movably coupled to one of the bowl and the handle. The lever is coupled to the cover and is configured to move between a first position and a second position. The cover comprises a plurality of apertures and is movably coupled to the bowl or the handle between a first position and a second position. In the first position, the cover extends across and opposite to the mouth and in sufficiently close proximity to the mouth so as to inhibit passage of particulate, granular or flaked material between the mouth and the cover. In the second position, the cover extends to one side of the mouth substantially exposing a cavity defined by the bowl.

The present invention further relates to various features and combinations of features shown and described in the disclosed embodiments. Other ways in which the objects and features of the disclosed embodiments are accomplished will be described in the following specification or will become apparent to those skilled in the art after they have read this specification. Such other ways are deemed to fall within the scope of the disclosed embodiments if they fall within the scope of the claims which follow.

### BRIEF DESCRIPTION OF THE DRAWINGS

FIG. 1 is a top plan view of a dispenser in a closed configuration according to an exemplary embodiment.

FIG. 2 is a top plan view of the dispenser in FIG. 1 in an open configuration.

FIG. 3 is a side section view of the dispenser in FIG. 1.

FIG. 4 is a side section view of the portion dispenser in FIG. 3 turned upside down and dispensing product.

FIG. 5 is right elevation view of the portion dispenser in FIG. 1 with an arrow indicating location of actuation by a user.

FIGS. 6-8 are perspective views a portion dispenser according to exemplary embodiments.

FIG. 9 is a view top plan view of a dispenser with various dispensing lids.

FIG. 10 is a perspective view of a dispenser in the open position collecting product to be dispensed.

FIG. 11 is a side view showing the dispenser of FIG. 10 dispensing the product on a food item.

FIG. 12 is a perspective view of a dispenser according to another exemplary embodiment in a closed configuration.

FIG. 13 is a perspective view of the dispenser in FIG. 12 in use and in an open configuration.

### DETAILED DESCRIPTION OF THE PREFERRED AND EXEMPLARY EMBODIMENTS

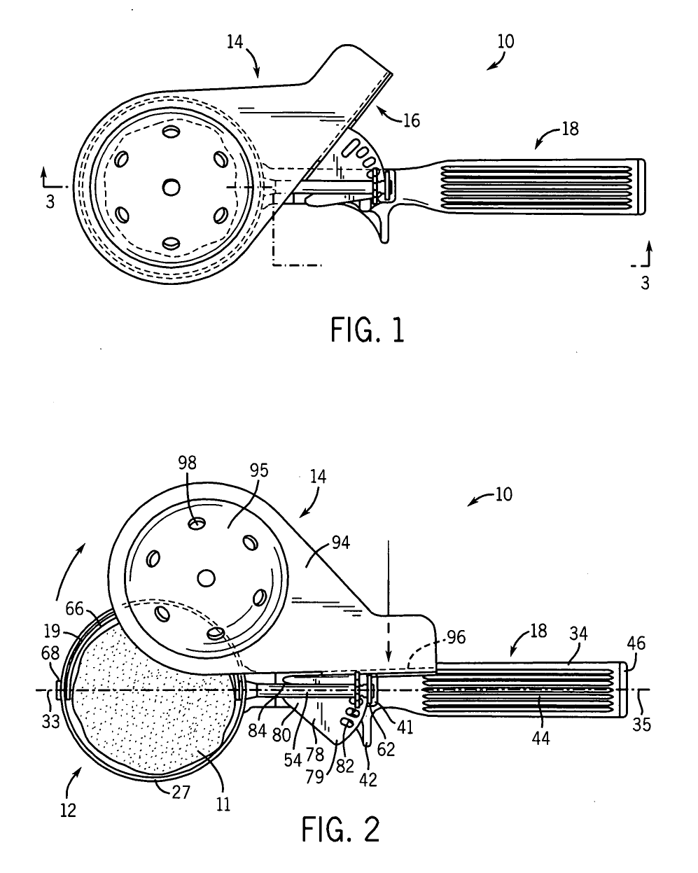

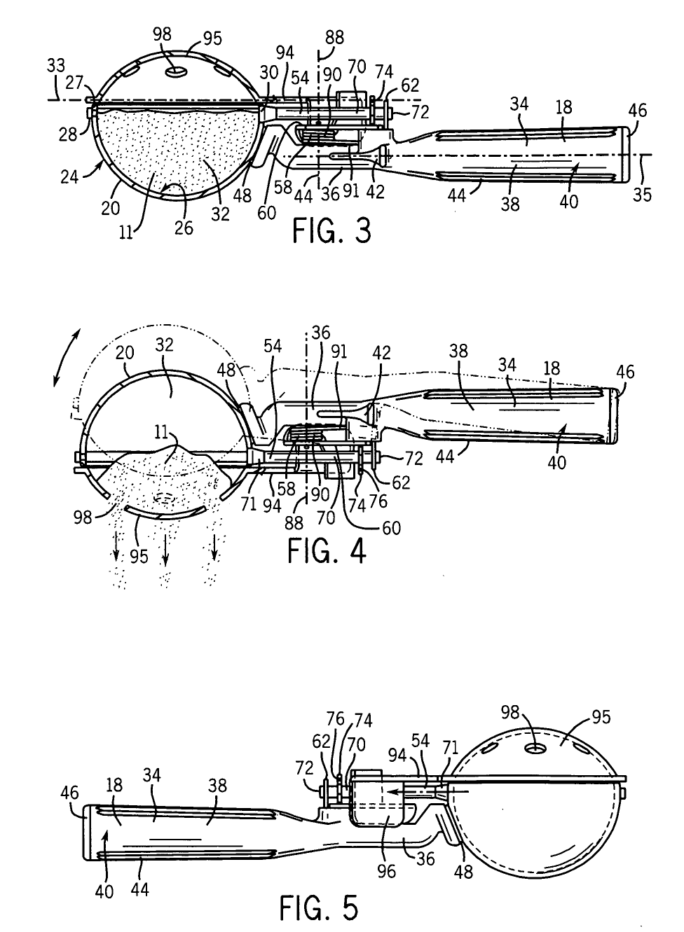

Referring to FIGS. 1-5, a utensil 10 (e.g., tool, instrument, device, etc.) is shown according to an exemplary embodiment. Utensil 10 is configured to collect a predetermined portion of a material or product 11 and distribute it through a series of apertures. The “product” may be any of a variety of separable materials, granules, particulates, powder, pellets, particles, bits, pieces, crumbs, or the like, including food product (e.g., spices, ingredients, graded cheese, etc.), decorative product, or the like. Utensil 10 comprises a server assembly 12, a lid 14, an actuator 16 for moving lid 14, a handle 18 and a separator 19.

Server assembly 12 comprises a base or working end (e.g., holder, vessel, container, bowl, reservoir, basin, scoop, head, etc.), shown as receptacle 20, and a support member that is integrally molded with the handle. According to an exemplary embodiment, receptacle 20 is a generally bowl-shaped structure configured to collect a product 11 (i.e., particulate, flaked or granular foodstuffs). Receptacle 20 comprises an exterior surface 24, an interior surface 26, and a rim 27.

Interior surface 26 defines an interior cavity 32 configured for holding the food product 11. In this embodiment, cavity 32 is preferably generally hemispherical and includes a diametral axis 33 that is generally parallel with longitudinal axis 35 of handle 18. Rim 27 defines the entrance or mouth to cavity 32 and may spread outward slightly or otherwise interrupt the profile of receptacle 20.

Lid 14 is configured to move (e.g., pivot, rotate, translate, slide, etc.) between a first position (e.g., closed, static, rest, unbiased, etc.) and a second position (e.g., open, extended, deployed, actuated, biased, etc.) by operation of actuator 16. Lid 14 is configured to substantially cover cavity 32 when actuator 16 is in its first position. Lid 14 comprises a cover 94, a user interface (shown as lever 96) and one or more apertures 98 (e.g., holes, openings, perforations, slots, etc.). Cover 94 is a generally flat member that is generally parallel to the plane defined by rim 27 and configured to generally abut and slide across rim 27. According to one exemplary embodiment, cover 94 includes a bulbous portion 95. Bulbous portion 95 is generally hemispherical with a diameter slightly smaller than the diameter of rim 27 and has a concave side facing cavity 32. Lever 96 extends downward beyond cover 94 and is configured to comfortably receive the thumb or finger of a person using utensil 10. According to an exemplary embodiment, lever 96 is generally perpendicular actuator 16 and coupled to actuator 16. Apertures 98 are configured to allow a user to empty product 11 from cavity 32 at a generally controlled rate. According to exemplary embodiments, the apertures may be any of a variety of shapes, orientations, configurations, sizes, quantity, or mixtures and combinations thereof, including but not limited to circular, ovular, elliptical, slots, rectangular, elongated, and the like. The apertures may be selected based on the product intended to dispense and the rate at which it is to be dispensed. As the user directs an actuating force against lever 96 and generally towards handle 18, actuator 16 pivots about an actuator axis 88 to move lid 14 from its first position to its second position and uncover cavity 32.

The first position (FIG. 1) of lid 14 that corresponds with the rest or unbiased position of actuator 16 in which lid 14 extends across and opposite to substantially any portion of rim 27 and the second position (FIG. 2) is where lid 14 is disposed offset from receptacle 20 to expose at least a portion of rim 27. According to an exemplary embodiment, lid 14 does not completely expose cavity 32 and rests at least partially on rim 27 in the second position. This overlap is intended to reduce the chance of lid 14 “binding” by being forced below rim 27. Alternatively, the lid may be configured to be actuated to completely expose rim 27.

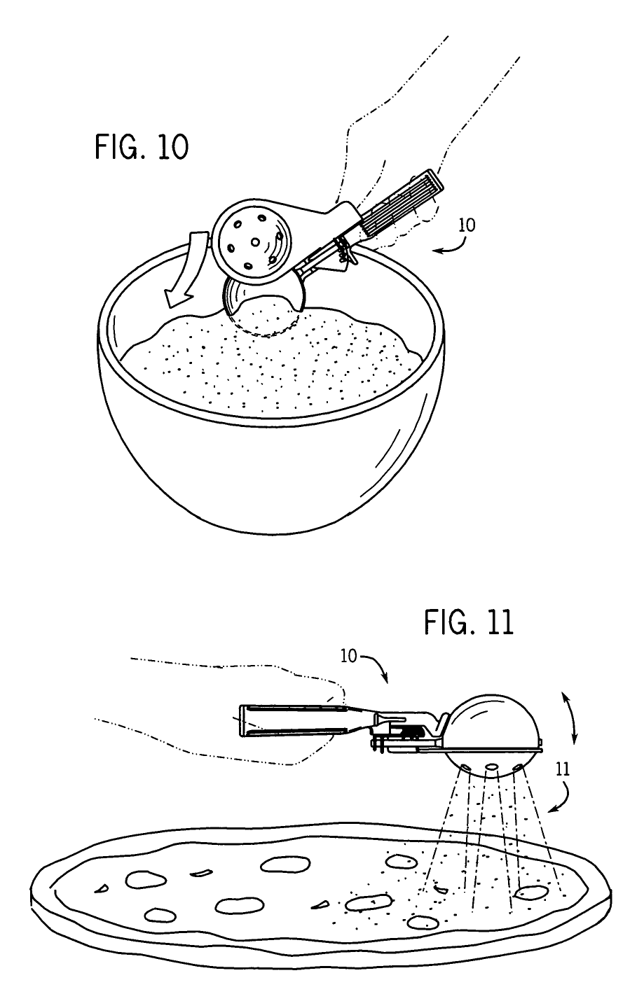

Referring to FIGS. 1-5, 10, and 11, to operate utensil 10, a user first depresses lever 96, thereby compressing a bias member 58 (e.g., spring) to at least partially expose cavity 32. Product 11 is then collected in cavity 32 and pressure on actuator 96 is reduced, allowing bias member 58 to force lid 14 to the first position, substantially trapping product 11 in cavity 32. Lid 14 acts to scrape away any extra product that is mounded above rim 27 as it moves from the second to the first position. User upends utensil 10, turning it so the product 11 can escape through perforations 98, which allow for the product 11 to be dispensed at a generally slower rate than if cavity was uncovered. The slower rate allows the product 11 to be spread more evenly. Side to side and/or up and down (shaking) movements may be used to encourage the product 11 out of the receptacle.

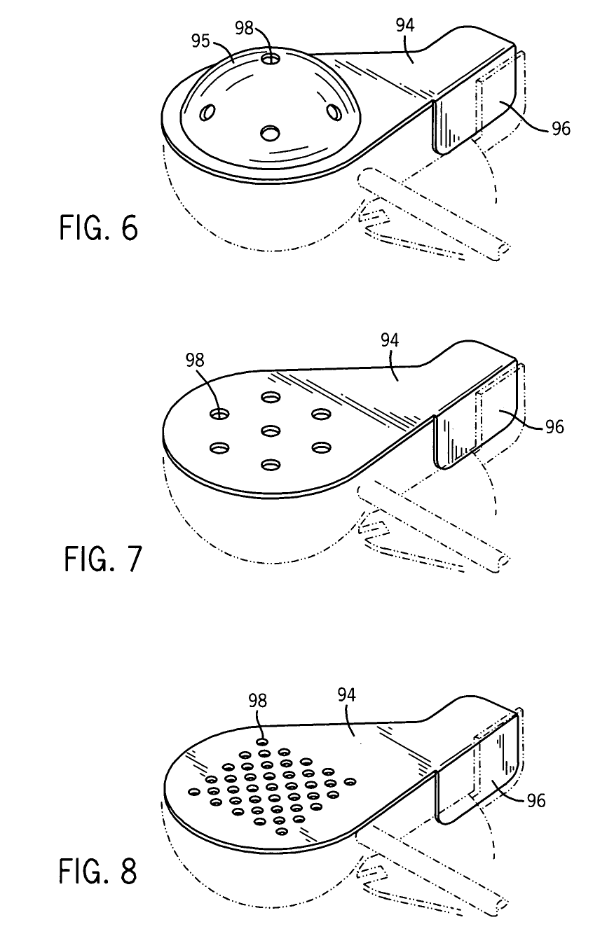

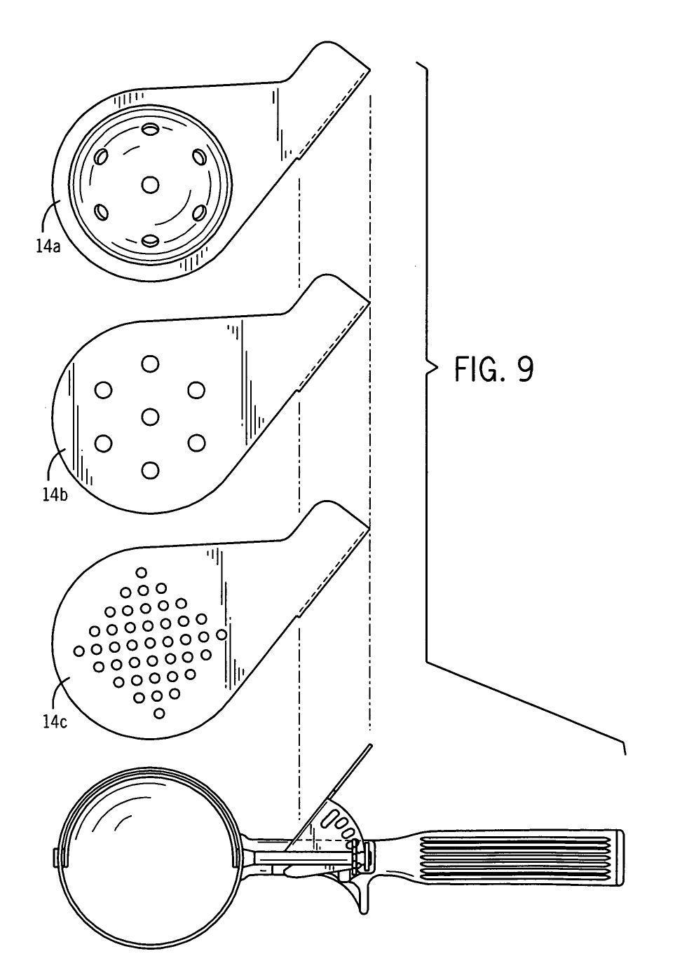

Referring to FIGS. 6-9, a utensil 10 is shown according to several exemplary embodiments. According to other exemplary embodiments, lid 14 may lack a bulbous portion and instead be substantially flat. FIG. 9 shows a utensil 10 with various lids 14a, 14b, 14c. An assortment of lids 14a, 14b, 14c may be used, providing various contours or apertures to accommodate a wide variety of products. Utensil 10 is preferably used to collect and distribute food ingredients, but alternate perforation patterns are possible, varied in perforation size and distribution, to accommodate various products.

Referring to FIGS. 4 and 9, receptacle further comprises a first aperture 28 and a second aperture 30. First aperture 28 and a second aperture 30 are openings (e.g., holes, passages, etc.) substantially aligned with diametral axis 33 and extending through receptacle 20 from exterior surface 24 to interior surface 26. Apertures 28, 30 are configured to receive separator 19.

The stem 22 is configured to support receptacle 20 and substantially couple server assembly 12 to handle 18 and separator 19. The stem is coupled on one end, preferably by welding, to exterior surface 24 and extends away from receptacle 20 generally along longitudinal axis 35. The stem may have a generally circular end that is welded to receptacle 20 and a distal end with a generally U-shaped cross section.

Utensil 10 also includes a handle 18 which is generally aligned with a longitudinal axis 35 and is coupled to stem 22. Handle 18 provides a body to be gripped by the hand of the user and comprises a body 34 and an end cap 46 and may include a sealing member 48. Body 34 comprises a solid portion 36 proximate to receptacle 20, a hollow portion 38, a generally smooth exterior surface 40, a bearing surface 41, an integral finger brace 42, and a gripping surface 44. According to an exemplary embodiment, body 34 is a thermoplastic and formed by an injection molding process. Body 34 has a solid portion 36 that generally envelops stem 22 where it extends away from receptacle 20 and a hollow portion 38 that is generally hollow to reduce the weight of utensil and reduce the amount of material needed to manufacture body 34. Bearing surface 41 is a raised boss extending from solid portion 36 and is configured to support rack 78. Finger brace 42 extends from solid portion 36 proximate to bearing surface 41 and provides a ledge against which a user's finger can rest, limiting movement of a user's hand along longitudinal axis 35. Gripping surface 44, shown schematically as a series of longitudinal ridges, corresponds generally with hollow portion 38 and may be comprise a substantially separate upper section and a lower section to simplify the mold needed to form body 34.

An end cap 46 closes the open end of hollow portion 38. According to an exemplary embodiment, end cap 46 is coupled to body 34 with an interference fit. According to other exemplary embodiments, end cap 46 may be integral or be fastened to body 34 in a variety of ways.

A sealing member 48 (e.g., o-ring, a ring of nitrile rubber, etc.) may be provided to seal the surface where body 34 is coupled to receptacle 20, or may be trapped between body 34 and receptacle 20.

Actuator 16 is coupled to lid 14 and to separator 19 and comprises a tab assembly 50, a drive 54, and a bias member 58. Tab assembly 50 is configured to at least partially anchor actuator 16 and is also configured to act as a pivot point for one or more components of actuator 16. Tab assembly comprises a first tab 60 and a second tab 62 that are generally flat members at least partially enveloped by the material of body 34. First tab 60 is positioned approximately midway along solid portion 36 while second tab 62 is positioned at the distal end of solid portion 36 proximate to hollow portion 38. Tabs 60 and 62 may be a unitary body, connected by base (which is embedded in the handle) that is coupled to stem 22. According to an exemplary embodiment, tab assembly 50 is welded to stem 22. According to other exemplary embodiments, tab assembly may be coupled to stem 22 with an adhesive, a fastener, or trapped against the stem by the material of body 34. According to still other exemplary embodiments, tab assembly 50 and stem 22 may be a single unitary body. First tab 60 includes a pair of notches that extend inward from the edges of first tab 60 near the distal end that are configured to engage rack 78, described in greater detail below. Second tab 62 includes an aperture such as a substantially round hole that that is configured to receives shaft 70.

Rack 78 is coupled to lever 96 and transfers input from the user (e.g., a movement of the thumb or finger) to drive 54. Rack 78 and an actuator lever 96 generally rotate about an actuator axis 88. Rack 78 is a flat, generally wedge-shaped member with a broad end 79 and a narrow end 80. A plurality of apertures 82 are provided along broad end 79 arranged in an arc and appropriately spaced for interaction with gear teeth 76 to translate transverse pivotal motion of rack 78 into rotational motion of drive 54. Narrow end 80 forms a slot 84 which pivotably engages first tab 60. According to an exemplary embodiment, slot 84 has a width that is less than the overall width of first tab 60, but greater than the width of first tab 60 at the notches. Slot 84 slidingly engages the notches and allows rack 78 to pivot about actuator axis 88 which is generally coaxial with first tab 60. Second tab 62 is preferably located close to broad end 79 to prevent rack 78 from disengaging first tab 60. According to an exemplary embodiment, rack 78 forms a unitary body with lid 14, or may be a separate lever coupled to a rack by welding, mechanical fasteners or another suitable coupling method.

Bias member 58 is preferably a coil spring having a center coil portion 90 and a pair of extending legs 91 that extend from coil portion 90 substantially along a tangent to coil portion 90. Coil portion 90 encircles first tab 60 and is disposed between handle 18 and rack 78. Legs 91 are trapped between lever 96 and bearing surface 41 and bias lever 96 toward the first position. As lever 96 is moved from its first position towards handle 18, additional potential energy is stored in bias member 58. When the actuating force is released from lever 96, the stored potential energy in bias member 58 will return lever 96 to its first position.

Drive 54 transfers movement from an actuator 16 to separator 19. Drive 54 comprises a shaft 70 and a toothed member shown as pinion gear 74. Shaft 70 is a generally cylindrical member having a first end 71 and a second end 72 and is generally aligned with diametral axis 33. First end 71 is preferably of expanded diameter and rotatably received in second aperture 30. Second end 72 is rotatably received in the aperture. Pinion gear 74 is coupled to shaft 70 proximate to second end 72 and includes a plurality of teeth 76 designed to cooperate with rack 78. In operation, as rack 78 is moved, pinion gear 74 and shaft 70 are rotated, pivoting separator 19 in cavity 32.

Separator 19 is configured to substantially remove any product that may remain in cavity 32. Separator 19 is coupled to a drive 54 and configured to pivotally move within cavity 32. Separator 19 comprises a curved member, shown as sweep 66 and a bearing 68. Sweep 66, preferably a thin metal band, which is generally semicircular, is configured to move substantially adjacent interior surface 26 to separate product from interior surface 26. Sweep 66 is connected in one end to a bearing 68 which is rotatably received in first aperture 28. The end of sweep 66 opposite bearing 68 is coupled to drive 54, which is rotatably received in second aperture 30.

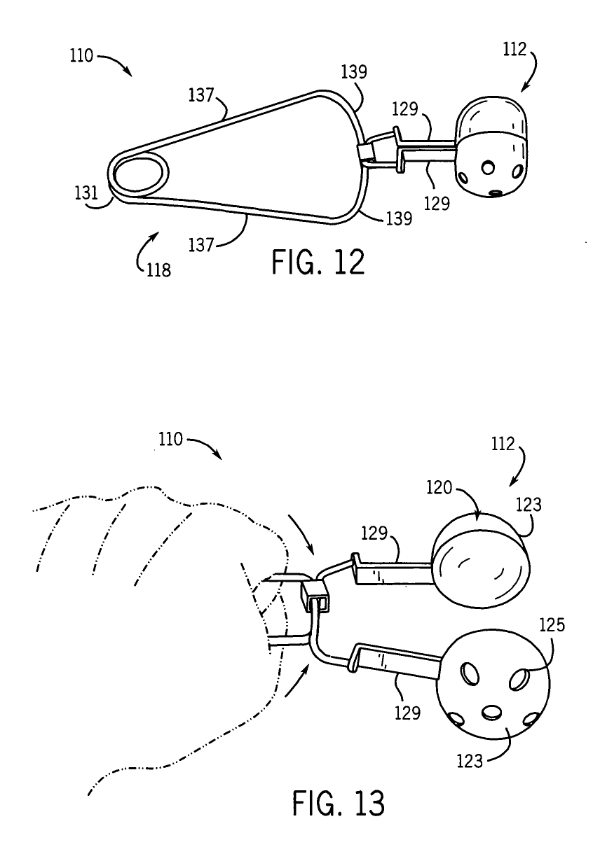

Referring to FIGS. 12-13, a utensil 110 is shown according to an alternative embodiment. Utensil 110 is configured to collect a predetermined portion of a product and distribute it through a series of apertures. Utensil 110 comprises a working end, shown as server assembly 112, a handle 118, and a collar 119. According to an exemplary embodiment, server assembly 112 comprises a receptacle 120 and a pair of arms 129 coupled to receptacle 120. According to an exemplary embodiment, receptacle 120 is a generally sphere-shaped structure configured to collect a product (i.e., particulate, flaked or granular foodstuffs). Receptacle 120 is separated into two generally hemispherical portions, shown as cups 123 (e.g., holders, vessels, containers, bowls, reservoirs, basins, scoops, heads, etc.) that form a substantially continuous body when utensil 110 is in a closed configuration. At least one of the cups 123 comprises a series of openings, shown as apertures 125. Apertures 125 are configured to allow a user to dispense (e.g., empty) a product from receptacle 120 at a generally predetermined and controlled rate. Cups 123 are coupled to arms 129. Arms 129 extend outward from cups and are coupled to handle 118.

Handle 118 is configured to provide an interface and grip for a user and is moveable between an open configuration and a closed configuration by a user closing his or her hand (e.g., squeezing of the handle). According to an exemplary embodiment, handle 118 comprises a biasing portion 131, two radial portions 137, and two circumferential portions 139. Biasing portion 131 is shown as a generally coiled member (e.g., spring). According to an exemplary embodiment, a pair of radial portions 137 extend from biasing portion 131. Radial portions 137 are configured to be manipulated by a user to hold utensil 110 and move utensil 110 from a closed configuration to an open configuration. A pair of circumferential portions 139 are coupled to radial portions 137 and to arms. Each circumferential portion 139 extends from the end of a radial portion 137 opposite biasing portion 131 and toward the other radial portion 137. Circumferential portions 139 generally correspond to an arc defined by radial portions 137 and an axis passing through the center of biasing portion 131. Circumferential portions 139 pass through a generally hollow member, shown as a collar 119. Collar 119 is configured to partially retain radial portions 137 and allow them to slide relative to each other when utensil 110 is moved from a closed configuration to an open configuration.

To operate utensil 110, a user first depresses radial portions 137, thereby compressing biasing portion 131 to at least partially separate cups 123. The working end is inserted into the product to be dispensed and the product is then collected in cups 123 when pressure on radial portions 137 is reduced, allowing biasing portion 131 to force cups 123 together, substantially trapping product in receptacle 120. User upends utensil 110, turning it so the product can escape through apertures 125 at a generally slower rate than if the product was poured from an open container. The slower rate allows the product to be spread more evenly. Side to side and/or up and down (shaking) movements may be used to encourage the product out of the receptacle.

According to a particularly preferred embodiment, the server assembly and handle are of the form as described in U.S. Pat. No. 5,326,248 which is hereby incorporated herein by reference.

While the components of the disclosed embodiments have been illustrated as a disher utensil designed for collecting and distributing particulate food matter such as grated parmesan cheese, the features of the disclosed embodiments have a much wider applicability. For example, the lid design is adaptable for other utensils, tools, and other commercial, industrial, or consumer products which employ dispensing a measured amount of material. Further, the size of the various components and the size of the apertures can be widely varied.

Also, the particular materials used to construct the exemplary embodiments are also illustrative. For example, molded nylon is the preferred method and material for making the handle, and stainless steel is the preferred material for the receptacle and lid, but other materials can be used, including other thermoplastic, thermoset, or elastomer resins, or other metals such as aluminum.

Further, it is important to note that the term “utensil,” “receptacle,” and “lid” are intended to be broad terms and not terms of limitation. These components may be used with any of a variety of products or arrangements and are not intended to be limited to use with food service applications.

It is also important to note that the construction and arrangement of the elements of the utensil as shown in the preferred and other exemplary embodiments are illustrative only. Although only a few embodiments of the present invention have been described in detail in this disclosure, those skilled in the art who review this disclosure will readily appreciate that many modifications are possible (e.g., variations in sizes, dimensions, structures, shapes and proportions of the various elements, values of parameters, mounting arrangements, materials, colors, orientations, etc.) without materially departing from the novel teachings and advantages of the subject matter recited in the claims. Accordingly, all such modifications are intended to be included within the scope of the present invention as defined in the appended claims. The order or sequence of any process or method steps may be varied or re-sequenced according to alternative embodiments. In the claims, any means-plus-function clause is intended to cover the structures described herein as performing the recited function and not only structural equivalents but also equivalent structures. Other substitutions, modifications, changes and/or omissions may be made in the design, operating conditions and arrangement of the preferred and other exemplary embodiments without departing from the spirit of the present invention as expressed in the appended claims.

What is claimed is:

1. A utensil for dispensing material comprising:
an elongated handle;
a receptacle coupled to the handle and including a rim defining an opening in the receptacle; and
a perforated lid movably coupled to one of the receptacle and the handle so as to move between a first position in which the lid extends across and opposite to substantially any portion of the rim and a second position in which the lid is disposed offset from the receptacle to expose at least a portion of the rim;
wherein the receptacle is configured to receive material when the lid is in the second position and the perforated lid is configured to allow the material to be dispensed when the lid is in the first position.

2. The utensil of claim 1 wherein the lid pivots between the first position and the second position.

3. The utensil of claim 1 wherein the lid includes a perforated bulbous portion opposite the receptacle when the lid is in the first position.

4. The utensil of claim 3 wherein the bulbous portion has a concave side facing the receptacle.

5. The utensil of claim 1 further comprising a manual depressant surface extending from the lid and configured to be engaged by a user's thumb of a hand which the user's fingers of the hand are wrapped about the handle.

6. The utensil of claim 5 wherein the lid is configured to move from the first position towards the second position as the surface is moved toward the handle.

7. The utensil of claim 1 further comprising a curved member in the receptacle and operably coupled to the lid such that the curved member moves in the receptacle in response to movement of the lid.

8. The utensil of claim 7 further comprising:
a toothed member coupled to the curved member; and
a rack member coupled to the lid such that the rack member rotates the toothed member in response to movement of the lid.

9. The utensil of claim 8 wherein the rack member includes apertures configured to receive teeth of the toothed member during movement of the rack member.

10. The utensil of claim 1 wherein the lid is resiliently biased toward the first position.

11. The utensil of claim 1 wherein the lid comprises a substantially flat perforated portion opposite the receptacle when the lid is in the first position.

12. The utensil of claim 1 wherein the lid comprises at a plurality of perforations opposite the receptacle when the lid is in the first position.

13. The utensil of claim 12 wherein the perforations are sized to sift parmesan cheese.

14. The utensil of claim 13 wherein the perforations are sized to sift red pepper.

15. The utensil of claim 13 wherein the perforations are uniformly distributed across a majority of a portion of the lid opposite the receptacle when the lid is in the first position.

16. The utensil of claim 1 wherein the rim and at least a portion of the lid are substantially coplanar when the lid is in the second position.

17. The utensil of claim 1 wherein the rim is annular.

18. A method comprising:
moving a lid by actuating a lever from a first position in which the lid is opposite a receptacle to a second position in which the lid at least partially exposes a cavity defined by the receptacle;
inserting the receptacle into material such that the material enters the receptacle through a rim that defines an opening in the receptacle;
moving the lid across the rim to a second position;
dispensing the material within the receptacle through one or more perforations in the lid.

19. The method of claim 18 pivoting the lid between its first position and the second position.

20. The method of claim 18 further comprising sweeping the material along a floor of the receptacle.

21. A utensil comprising:
an elongated handle;
a bowl coupled to the handle and including a mouth; and
a cover having a plurality of apertures and movably coupled to one of the bowl and the handle so as to move between a first position in which the lid extends across and opposite to the mouth and in sufficiently close proximity to the mouth so as to inhibit passage of particulate, granular or flaked material between the mouth and the cover and a second position in which the cover extends to one side of the mouth and substantially exposing a cavity defined by the bowl;
a lever coupled to the cover and configured to move the lever between the first position and the second position.

22. The utensil of claim 21 wherein the cover is offset from the mouth by an amount less than the outside dimension of the bowl at the mouth when the cover is in first position

23. The utensil of claim 21 wherein the cover is spaced apart from the mouth of the bowl when in the first position.
